(19) United States
(12) Patent Application Publication
(10) Pub. No.: US 2005/0280862 A1
(43) Pub. Date: Dec. 22, 2005

(54) AV apparatus and method of controlling the same

(75) Inventor: Michihiro Fukushima, Fuchu-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/152,778

(22) Filed: Jun. 15, 2005

(30) Foreign Application Priority Data
Jun. 16, 2004 (JP) 2004-178483

(51) Int. Cl. G06F 15/00

(52) U.S. Cl. 358/1.15

(57) ABSTRACT

An address is allocated to a device connected to a network by using a DHCP server function, and with reference to a management table in which the allocated address and identification information of the device are corresponded with each other, displays a screen for selecting the device. An HTTP request is issued to the device selected on the screen. When a response from the device is valid, a display based on the response from the device is executed by using an HTML browser function.

### CROSS-REFERENCE TO RELATED APPLICATIONS

This application is based upon and claims the benefit of priority from prior Japanese Patent Application No. 2004-178483, filed Jun. 16, 2004, the entire contents of which are incorporated herein by reference.

### BACKGROUND OF THE INVENTION

1. Field of the Invention

The present invention relates to an audio video (AV) apparatus including a television (TV) receiver, a set-top box (STB), a digital versatile disk (DVD) recorder and a personal computer (PC) and a method of controlling the same, and more particularly, to an apparatus connected to a network for use.

2. Description of the Related Art

As well known, in recent years, resources possessed by storage devices connected to a network can be used by connecting the aforementioned AV apparatus to the network.

For the AV apparatus connected to a network to use a resource possessed by a storage device connected to the same network, it is necessary for a user to register information indicating a storage device connected to the network and information indicating a resource possessed by each storage device preliminarily.

Jpn. Pat. Appln. KOKAI Publication No. 2000-222335 and U.S. Pat. No. 6,556,875 have disclosed device control systems which enable a device object to use information possessed by another device object on a network easily by using an application program without depending on the kind of the device object and the kind of a communication path.

However, because the device control systems disclosed by the Jpn. Pat. Appln. KOKAI Publication No. 2000-222335 and the U.S. Pat. No. 6,556,875 require specialized application programs, it is not difficult to say that inconvenience in handling for the user has been eliminated completely but currently, they are not suitable for a practical use.

### BRIEF SUMMARY OF THE INVENTION

According to one aspect of the present invention, there is provided an AV apparatus comprising: an address allocating portion configured to allocate an address to a device connected to a network; a storage portion configured to store a management table in which identification information of the device to which the address has been allocated by the address allocating portion and the address allocated to the device are corresponded with each other; a first display control portion configured to display a screen for selecting the device connected to the network with reference to the management table stored in the storage portion; an issuing portion configured to issue a communication request to the device selected on the screen displayed by the first display control portion; a determining portion configured to determine whether or not a response from the device to the communication request issued by the issuing portion is valid; and a second display control portion configured to, when the determining portion determines that the response is valid, carry out display based on the response from the device.

According to another aspect of the present invention, there is provided a method of controlling an AV apparatus connected to a network, comprising: a first step of allocating an address to a device connected to the network; a second step of storing a management table in which identification information of the device to which the address has been allocated and the address allocated to the device are corresponded with each other; a third step of displaying a screen for selecting the device connected to the network with reference to the management table; a fourth step of issuing a communication request to the device selected on the displayed screen; a fifth step of determining whether or not a response from the device to the issued communication request is valid; and a sixth step of, when it is determined that the response is valid, carrying out a display based on the response from the device.

### BRIEF DESCRIPTION OF THE SEVERAL VIEWS OF THE DRAWING

FIG. 1 is a block diagram for explaining an outline of a network system according to an embodiment of the present invention;

FIG. 2 is a flow chart for explaining an operation of a TV apparatus at the time of connecting a device according to the embodiment;

FIG. 3 is a diagram for explaining a management table A possessed by the TV receiver according to the embodiment;

FIG. 4 is a flow chart for explaining major operations of the TV receiver according to the embodiment;

FIG. 5 is a view for explaining an example of a device selection screen of the TV receiver according to the embodiment;

FIG. 6 is a view for explaining an example of a display screen using an HTML browser of the TV receiver according to the embodiment;

FIG. 7 is a view for explaining a specific example of the HTML browser display screen of the TV receiver according to the embodiment;

FIG. 8 is a view for explaining a further specific example of the HTML browser display screen of the TV receiver according to the embodiment;

FIG. 9 is a view for explaining an example of an error message screen of the TV receiver according to the embodiment;

FIG. 10 is a diagram for explaining a management table B possessed by the TV receiver according to the embodiment; and

FIG. 11 is a flow chart for explaining major operations of the TV receiver using the management table B according to the embodiment.

### DETAILED DESCRIPTION OF THE INVENTION

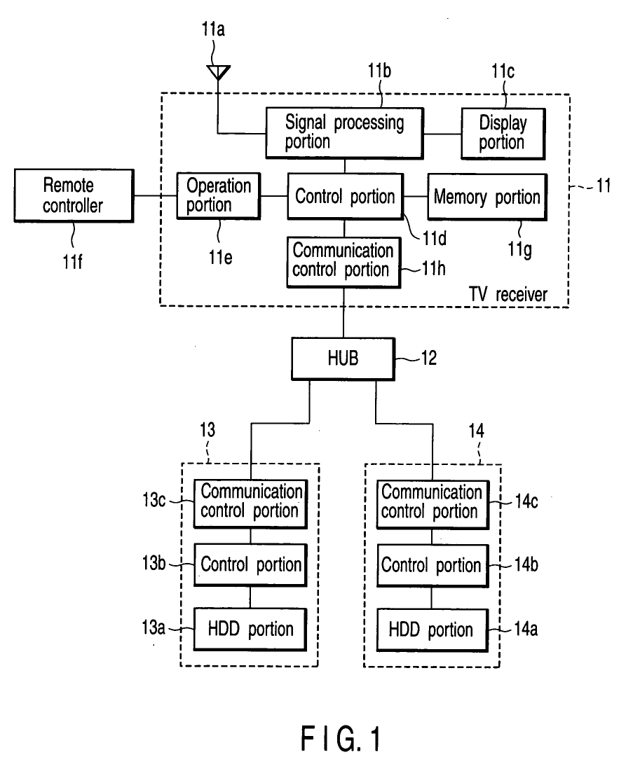

Hereinafter, an embodiment of the present invention will be described in detail with reference to the accompanying drawings. FIG. 1 schematically shows a network system to be described in this embodiment. That is, in the network system, plural (two in the example shown here) devices 13, 14 are connected to a TV receiver 11 as an AV apparatus through a HUB 12.

In the TV receiver 11, a signal processing portion 11b executes channel selection and demodulation processing on a television broadcasting signal received by an antenna 11a so as to restore a picture signal, and a picture is displayed on a display portion 11c. The signal processing portion 11b also demodulates an audio signal, and an audio is reproduced from a speaker (not shown).

The entire operation of the TV receiver 11 including the above-described receiving operation is controlled totally by a control portion 11d. The control portion 11d incorporates a central processing unit (CPU) and the like so as to control respective portions such that contents of operation sent from a operating portion 11e or a remote controller 11f is reflected.

In this case, the control portion 11d uses a memory portion 11g. That is, the memory portion 11g contains mainly a read only memory which stores a control program to be executed by the CPU of the control portion 11d, a write only memory which provides the CPU with a work area, and a nonvolatile memory which store various kinds of management tables, setting information, control information and the like.

The control portion 11d is connected to the hub 12 through a communication control portion 11h. The control portion 11d includes a dynamic host configuration protocol (DHCP) server function and a hypertext markup language (HTML) browser function, and is capable of communicating with the devices 13, 14 connected to the HUB 12.

The device 13 comprises a hard disk drive (HDD) portion 13a in which resource information, attribute information about the resource and the like are recorded, and recording/reproduction of information is carried out to/from the HDD portion 13a under the control of a control portion 13b. Further, the control portion 13b is connected to the HUB 12 through a communication control portion 13c, and has a hypertext transfer protocol (HTTP) server function.

The device 14 also has a hard disk drive (HDD) 14a in which resource information, attribute information about the resource and the like are recorded, and recording/reproduction of information is carried out to/from the HDD portion 14a under the control of a control portion 14b. Further, the control portion 14b is connected to the HUB 12 through a communication control portion 14c, and has an HTTP server function.

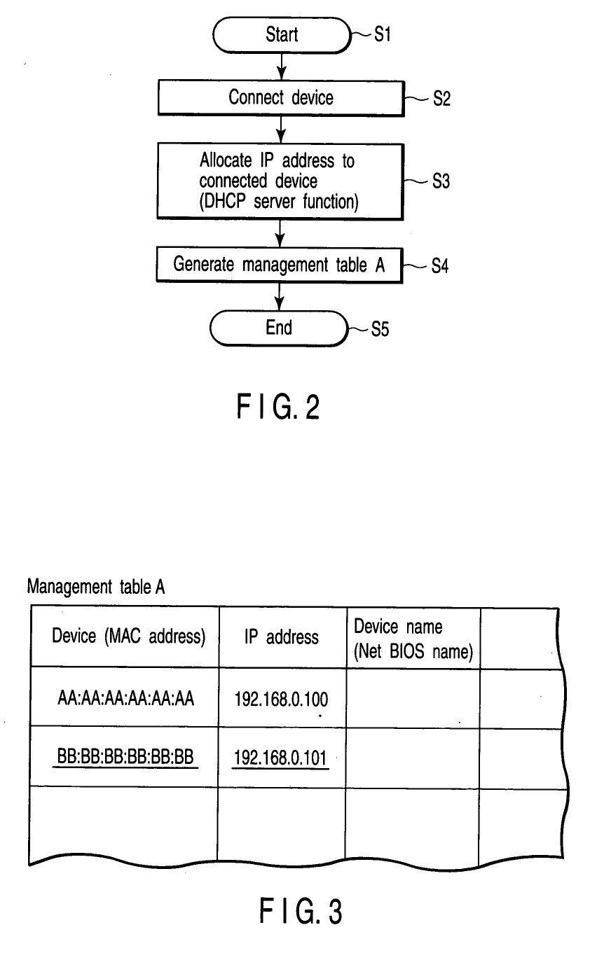

FIG. 2 shows a flow chart indicating the operation of the control portion 11d of the TV receiver 11 when the device 13 is connected to a network, that is, the HUB 12. Note that the same operation is executed when the device 14 is connected also.

That is, if the processing is started (step S1) and in step S2, the device 13 is connected to the HUB 12, the control portion 11d executes allocation of an internet protocol (IP) address to the connected device 13 by using the DHCP server function.

Thereafter, in step S4, the control portion 11d generates a management table A in which identification information of the device 13 to which the IP address has been allocated [media access control (MAC) address] and the allocated IP address are corresponded with each other, writes the generated table to the memory portion 11g and terminates the processing (step S5).

After the IP address has been allocated as described above, the device 13 becomes capable of communicating with the control portion 11d of the TV receiver 11 through a network by means of transmission control protocol (TCP)/IP.

FIG. 3 shows the detail of the management table A. That is, in case of the network system shown in FIG. 1, the MAC address and the IP address are corresponded with each other with respect to the two devices 13, 14. In the management table A shown in FIG. 3, a device name capable of identifying a device such as NetBIOS can be added as well as the MAC address and IP address.

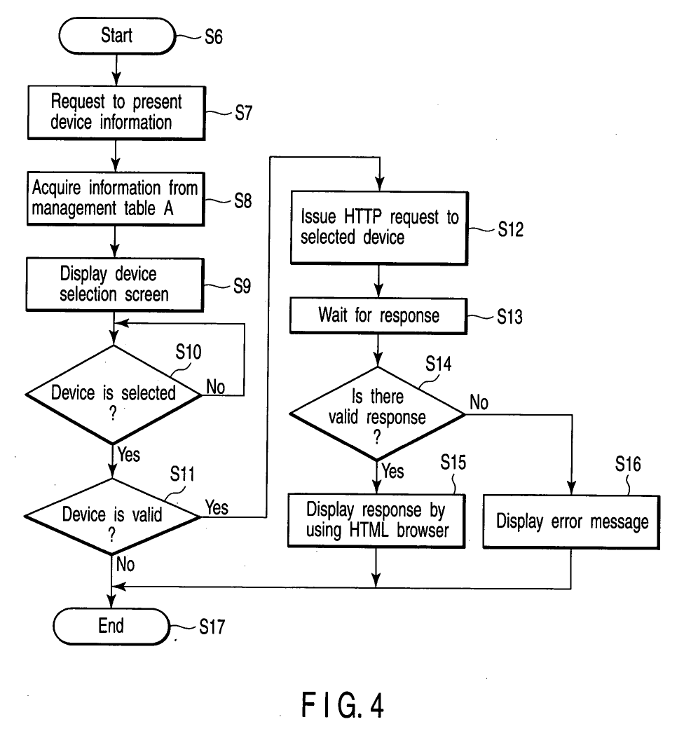

FIG. 4 shows a flow chart indicating the operation of the control portion 11d of the TV receiver 11 for presenting the user with information possessed by the devices 13, 14 connected to the network. That is, if the processing is started (step S6) and in step S7, presentation of device information is requested through the operating portion 11e or the remote controller 11f, the control portion 11d acquires information from the management table A in step S8, and displays a device selection screen on the display portion 11c in step S9.

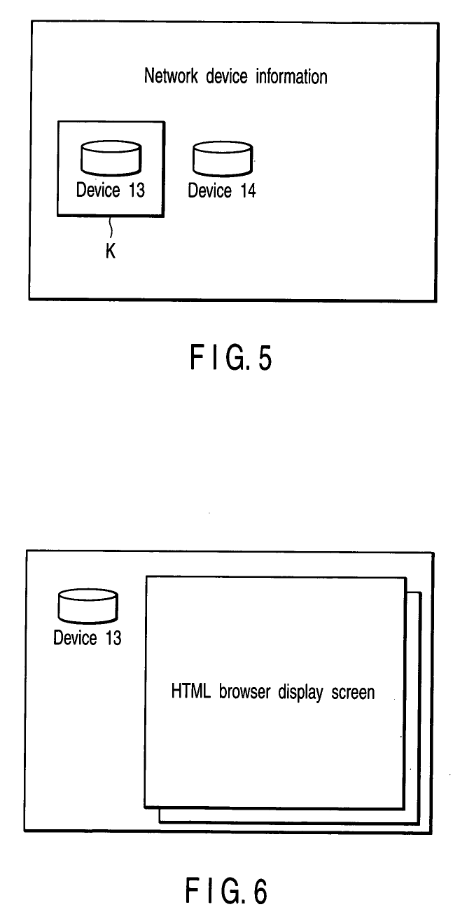

The device selection screen indicates all the devices 13, 14 to which the IP address has been allocated as shown in FIG. 5. Then, the user can select and decide a desired device by operating the remote controller 11f to move a cursor k on the screen.

In step S10, the control portion 11d waits for the predetermined device 13 or 14 to be selected from the device selection screen. For example, when it is determined that the device 13 is selected (YES), it is determined whether or not the selected device 13 is valid in step S11, and when it is determined that it is not valid (NO), the processing is terminated (step S17).

When it is determined that the device 13 selected in the step S11 is valid (YES), the control portion 11d, in step S12, assumes that the selected device 13 has the HTTP server function, acquires an IP address (192.168.0.xxx) allocated to the device 13 from the management table A, and issues an HTTP request (http://192.168.0.xxx) to the acquired IP address.

Thereafter, the control portion 11d waits for a response from the device 13 which has issued the HTTP request in step S13, and determines whether or not there is a valid response in step S14.

Then, when it is determined that such a valid response is obtained (YES), the control portion 11d displays the response on the display portion 11c by using the HTML browser function as shown in FIG. 6 (step S15), and terminates the processing (step S17). Subsequently, the user can use the information by communicating with the device 13 through the HTML browser while viewing the screen of the display portion 11c.

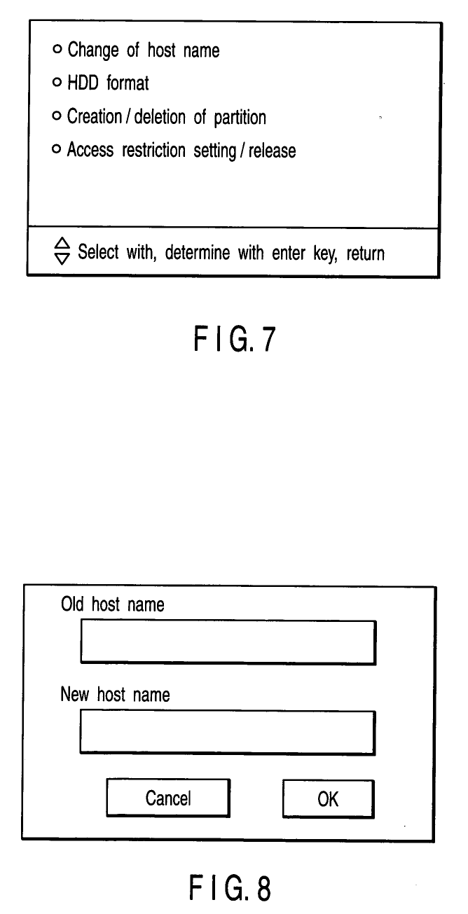

FIG. 7 shows an example of the screen in which a response from the device 13 is displayed on the display portion 11c by using the HTML browser function. That is, plural items such as change of a host name, format of the HDD, creation/deletion of partition, and access restriction setting/release can be selected by the operation of the remote controller 11f. For example, when the change of the host name is selected, a screen for inputting a new host name to the place of an old host name is displayed as shown in FIG. 8.

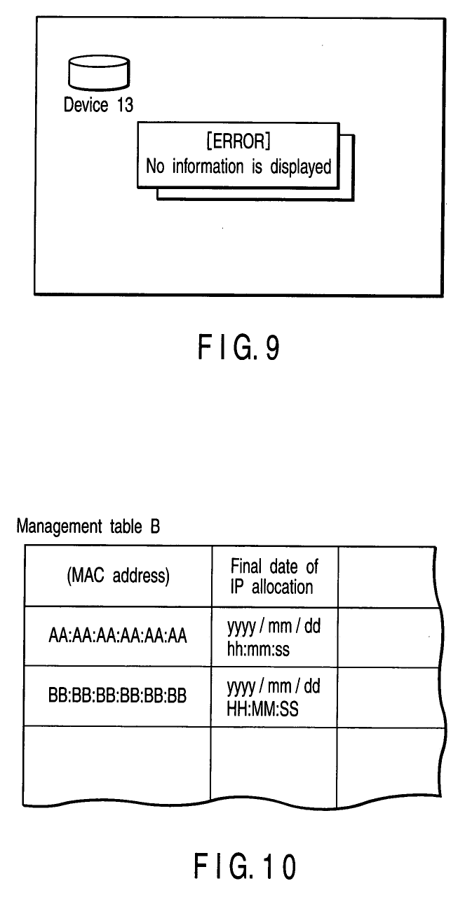

When it is determined that an effective response can not be obtained in the step S14 (NO), the control portion 11d determines that information of the device cannot be presented by using the HTML browser in step S16, causes the display portion 11c to display an error message as shown in FIG. 9, and terminates the processing (step S17).

According to the above-described embodiment, the TV receiver 11 allocates the IP address to the devices 13, 14 connected to the network by means of the DHCP server function, and generates the management table A in which the identification information of the devices 13, 14 to the IP address has been allocated and the allocated IP address are corresponded with each other. Thus, the TV receiver 11 can easily present the devices 13, 14 connected to the network with reference to the management table A.

When the user selects a desired device 13 from the presented devices 13, 14, the TV receiver 11 makes HTTP request to the selected device 13. If a normal response is obtained, the response is displayed by means of the HTML browser. Thus, the user can easily use information of the selected device 13.

Here, the control portion 11d of the TV receiver 11 not only creates the management table A in which the IP address allocated to the devices 13, 14 connected to the network and the MAC address of the devices 13, 14 are corresponded with each other but also creates a management table B in which the MAC address of each device 13, 14 and final date of allocating the IP address to the devices 13, 14 are corresponded with each other, and then stores it in the memory portion 11g.

Such a management table B is provided, whereby the TV receiver 11 can determine whether or not the device connected to the network is a device connected to the network first or whether or not it is a device which is not connected to the network for a specified period or more since the last IP address is allocated.

Because such a determination is achieved, the HTTP request is automatically issued to the device connected to the network first or the device which is not connected for a specified period or more since the last IP address is allocated, so that the information of that device can be presented to the user by using the HTML browser.

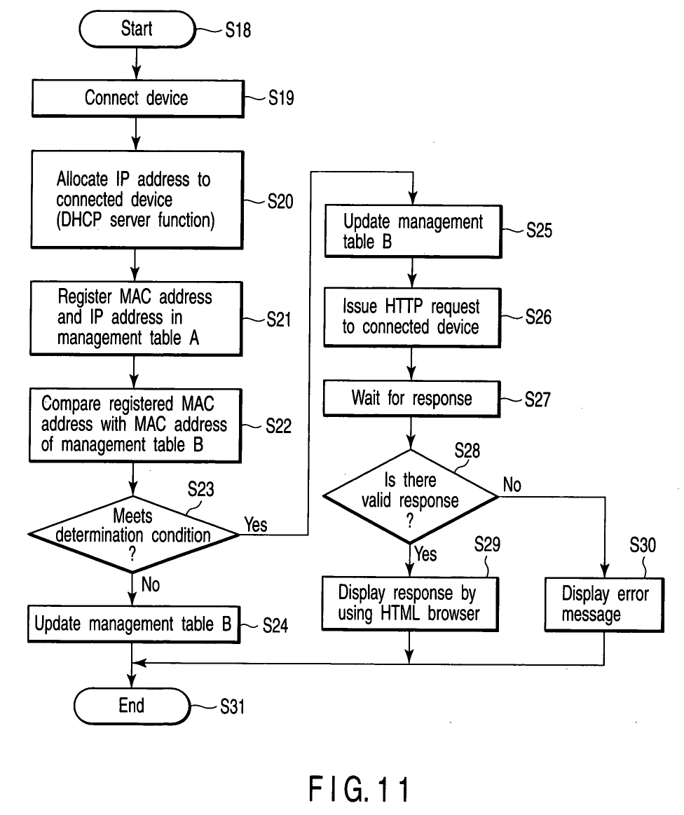

FIG. 11 shows a flow chart indicating the above-described operation performed by using the management table B. That is, if the processing is started (step S18) and, for example, the device 13 is connected to the hub 12 in step S19, the control portion 11d executes allocation of the IP address to the connected device 13 by means of the DHCP server function in step S20.

Thereafter, the control portion 11d registers the identification information (MAC address) of the device 13 to which the IP address has been allocated and the allocated IP address in the management table A in the memory portion 11g.

In step S22, the control portion 11d compares the MAC address registered in the management table A with the MAC address registered in the management table B of the memory portion 11g, and in step S23, determines whether or not the address meets a predetermined determination condition.

The determination condition includes whether or not the MAC address registered in the management table A coincides with the MAC address registered in the management table B, that is, whether or not the device 13 is connected to the network first, and whether or not the device 13 is a device which is not connected for a specified period or more since the last IP address is allocated if the MAC address registered in the management table A coincides with the MAC address registered in the management table B.

If in step S23, it is determined that it does not meet the predetermined determination condition (NO), the control portion 11d updates the content of the management table B in step S24, and terminates the processing (step S31).

If in the step S23, it is determined that it meets the predetermined determination condition (YES), the control portion 11d updates the content of the management table B in step S25, then assumes that the connected device 13 has the HTTP server function in step S26, and issues an HTTP request to the IP address allocated to the device 13.

Thereafter, the control portion 11d waits for a response from the device 13 which has issued the HTTP request in step S27, and determines whether or not there is any valid response in step S28.

If it is determined that the valid response is acquired (YES), the control portion 11d causes the display portion 11c to display the response by using the HTML browser function as shown in FIG. 6 in step S29, and terminates the processing (step S31). Subsequently, the user can use the information by communicating with the device 13 through the HTML browser while viewing the screen on the display portion 11c.

If it is determined that any valid response can be obtained in the step S28 (NO), the control portion 11d determines that the information of the device cannot be presented by using the HTML browser in step S30, causes the display portion 11c to display an error message shown in FIG. 9, and terminates the processing (step S31).

In the above-described embodiment, it is described that the TV receiver uses the information of the devices 13, 14 connected to the network. However, this is not restricted to the TV receiver 11 but the information can be applied widely to, for example, an AV apparatus including an STB, a DVD recorder, a PC and the like.

Further, the devices 13, 14 are not restricted to devices which store information in the HDD portions 13a, 14a, but may be those that store the information in, for example, a DVD, or a tape.

In the meantime, the present invention is not restricted to the above-described embodiment but may be embodied by modifying its components within a scope not departing from the gist of the invention at application stage. In addition, by combining plural components disclosed in the above-described embodiment appropriately, various aspects of the present invention can be formed. For example, it is permissible to delete some components from all the components shown in the embodiment. Moreover, it is permissible to combine components of different embodiments appropriately.

1. An AV apparatus comprising:
an address allocating portion configured to allocate an address to a device connected to a network;
a storage portion configured to store a management table in which identification information of the device to which the address has been allocated by the address allocating portion and the address allocated to the device are corresponded with each other;
a first display control portion configured to display a screen for selecting the device connected to the network with reference to the management table stored in the storage portion;
an issuing portion configured to issue a communication request to the device selected on the screen displayed by the first display control portion;
a determining portion configured to determine whether or not a response from the device to the communication request issued by the issuing portion is valid; and
a second display control portion configured to, when the determining portion determines that the response is valid, carry out display based on the response from the device.

2. The AV apparatus according to claim 1, wherein
the address allocating portion is configured to allocate an address to the device connected to the network by using a DHCP server function,
the issuing portion is configured to issue an HTTP request to the device selected on the screen displayed by the first display control portion,
the determining portion is configured to determine whether or not a response from the device to the HTTP request issued by the issuing portion is valid, and
the first display control portion is configured to, when the determining portion determines that the response is valid, carry out a display based on the response from the device by using an HTML browser function.

3. An AV apparatus comprising:
an address allocating portion configured to allocate an address to a device connected to a network;
a storage portion configured to store a management table in which identification information of the device to which the address has been allocated by the address allocating portion and information indicating the date of allocating the address to the device last are corresponded with each other;
a first determining portion configured to compare the identification information of the device to which the address has been allocated by the address allocating portion with the identification information of the device registered in the management table stored in the storage portion to determine whether or not the information meets a predetermined determination condition;
an issuing portion configured to, when the first determining portion determines that the information meets the predetermination condition, issue a communication request to the device to which the address has been allocated by the address allocating portion;
a second determining portion configured to determine whether or not a response from the device to the communication request issued by the issuing portion is valid; and
a display portion configured to, when the second determining portion determines that the response is valid, carry out a display based on the response from the device.

4. The AV apparatus according to claim 3, wherein
the address allocating portion is configured to allocate an address to the device connected to the network by using a DHCP server function,
the issuing portion is configured to, when the first determining portion determines that the information meets the predetermined determination condition, issue an HTTP request to the device to which the address has been allocated by the address allocating portion,
the second determining portion is configured to determine whether or not a response from the device to the HTTP request issued by the issuing portion is valid, and
the display portion is configured to, when the second determining portion determines that the response is valid, carry out a display based on the response from the device by using an HTML browser function.

5. The AV apparatus according to claim 3, wherein the first determining portion is configured to, when the identification information of the device to which the address has been allocated by the address allocating portion does not exist in the identification information of the device registered in the management table, determine that the information meets the determination condition.

6. The AV apparatus according to claim 3, wherein the first determining portion is configured to, when the device to which the address has been allocated by the address allocating portion is not connected for a predetermined period or more since the address is allocated last, determine that the information meets the determination condition.

7. A method of controlling an AV apparatus connected to a network, comprising:
a first step of allocating an address to a device connected to the network;
a second step of storing a management table in which identification information of the device to which the address has been allocated and the address allocated to the device are corresponded with each other;
a third step of displaying a screen for selecting the device connected to the network with reference to the management table;
a fourth step of issuing a communication request to the device selected on the displayed screen;
a fifth step of determining whether or not a response from the device to the issued communication request is valid; and
a sixth step of, when it is determined that the response is valid, carrying out a display based on the response from the device.

8. The method of controlling an AV apparatus, according to claim 7, wherein
the first step allocates an address to the device connected to the network by using a DHCP server function,
the fourth step issues an HTTP request to the device selected on the screen displayed in the third step,
the fifth step determines whether or not the response from the device to the HTTP request issued in the fourth step is valid, and
the sixth step carries out a display based on the response from the device by using an HTML browser function when it is determined that the response is valid in the fifth step.
